(19) United States
(12) Patent Application Publication
(10) Pub. No.: US 2013/0340338 A1
(43) Pub. Date: Dec. 26, 2013

(54) Hydroponic Device for Liquid Supply

(71) Applicant: Ming-Tsun Lin, Zhubei City (TW)

(72) Inventor: Ming-Tsun Lin, Zhubei City (TW)

(21) Appl. No.: 13/531,653

(22) Filed: Jun. 25, 2012

(51) Int. Cl. A01G 31/00

(52) U.S. Cl. 47/62 R

(57) ABSTRACT

The present invention is to provide a hydroponic device for liquid supply, which includes a plate, a bottle and a pump. The plate has an open space for filing liquid therein, and a diversion panel is mounted in the open space to separate a first flume, a second flume and a connection set. The bottle pours the liquid (e.g. culture solution) slowly into the plate via breaking through the surface tension of water. The motor is connected to the second flume and the connection set to pump the liquid, and the first flume introduces the liquid into the second flume through the connection set, to form a circulating fluid loop. As such, the present invention achieves the purposes of reducing the losses of water and nutrient for hydroponic culture such that the liquid can be utilized repeatedly via flowing through the circulating loop to accelerate the growing of plants.

### FIELD OF THE INVENTION

The present invention relates to a hydroponic device, and more particularly to a hydroponic device for liquid supply for reducing the losses of water and nutrient as well as cyclically furnishing liquid.

### DESCRIPTION OF RELATED ART

Generally, a conventional large farm is an open and flat soil-cultivated field. Such farms usually need large area, and they are easily affected by the climates resulting in unstable production and problems of biological pollution. Traditional soil-cultivation methods does not suit the people living metropolitan area, so water-cultivation methods also become popular in recent years. People that live in limited living spaces can plant vegetables in just like a corner in their own house by using water-cultivation, such that they can avoid to eat vegetables with agricultural chemicals sold in the markets, also enjoy the culturing processes with much pleasure and reduce the expenses of entertainment.

Crop culture is mainly performed by equipment to control the energy sources for the growing of plant, such like illumination, water and air, thereby obtain stable crops of quality and improve the output value of the crops.

Furthermore, the illumination and water are both very important factors for plant culture. Plants grow almost relying on the photosynthesis, thus the proper illumination is the most factors that can affect the quality of the growing of plants. General irrigation wastes too much time and efforts. As such, controlling the environment for plant growing is an important process for plant cultivation according to the growth habit, the developmental regular patterns and other characteristics of the plants.

### SUMMARY OF THE INVENTION

In view of the aforementioned problems of the prior art, it is a primary objective of the invention to provide a hydroponic device for liquid supply for reducing the losses of water and nutrient as well as cyclically furnishing liquid.

To achieve the foregoing objective, the present invention provides a hydroponic device for water supply comprising a plate, a bottle and a motor. The plate has an open space for filing liquid therein, and a first flume, a second flume, a connection set and a diversion panel. The diversion panel is mounted in the open space to partition the first flume, the second flume and the connection set. The bottle has an opening head inserted into the diversion panel to pour the liquid slowly into the plate via breaking through the surface tension of water. The motor is mounted in the plate and connected to the second flume and the connection set to pump the liquid, and the first flume is connected to the connection set to introduce the liquid into the second flume, to form a circulating fluid system, and the culture solution is diluted by being mixed with the fluid.

Preferably, the diversion panel is a flat plane.

Preferably, the diversion panel is an inclined plane.

Preferably, the diversion panel further comprises multiple guiding grooves, whereby the liquid cyclically flow from the first flume to the second flume.

Preferably, t the guiding grooves are level grooves or slanting grooves, whereby the liquid is guided and flow fluently.

Preferably, the plate further comprises a planting board and an LED light board which is both mounted in the plate, and form a plant cultivation assembly as a whole.

Preferably, the plate further comprises multiple brackets, the planting board is mounted onto the brackets and corresponding to the plate and the LED light board is fixed by the brackets and mounted on the planting board, to form a plant cultivation assembly as a whole.

Preferably, the device of the present invention further has multiple plant cultivation assemblies mounted parallelly in the brackets.

Preferably, each of the plant cultivation assemblies further comprises an air-conditioner mounted around thereof correspondingly, and each of the air-conditioner is formed by multiple sealing sheets and comprises a conditioning part mounted therein.

Preferably, the planting board is mounted against the diversion panel and the planting panel further comprises multiple holes for seedlings to dispose fixedly.

The plate further comprises a planting board and an LED light board. The planting board is mounted corresponding to the division panel and used for disposing the seedlings and cultivating them separately. By the circulating fluid system, the present invention can supply sufficient water and nutrient for the seedlings to grow, reduce the losses of water and nutrient and utilize the liquid repeatedly. Moreover, the LED light board is used for regulating temperature and light sources in order to provide illumination and stable conditions appropriately to accelerate the growing of the seedlings.

The technical contents and characteristics of the present invention will become apparent with the detailed description of a preferred embodiment accompanied with related drawings as follows.

### BRIEF DESCRIPTION OF THE DRAWINGS

FIG. 1 is a perspective view of a hydroponic device for liquid supply in accordance with the present invention;

FIG. 2 is a schematic view of a hydroponic device for liquid supply in accordance with the present invention;

FIG. 3 is an exploded view of a hydroponic device for liquid supply in accordance with the present invention;

FIGS. 4 is a schematic view of a diversion panel of a hydroponic device for liquid supply in accordance with the present invention;

FIG. 5 is another schematic view of a diversion panel of a hydroponic device for liquid supply in accordance with the present invention;

FIG. 6 is yet another schematic view of a diversion panel of a hydroponic device for liquid supply in accordance with the present invention;

FIG. 7 is further another schematic view of a diversion panel of a hydroponic device for liquid supply in accordance with the present invention;

FIG. 8 is a schematic view of a connection set of a hydroponic device for liquid supply in accordance with the present invention;

FIG. 9 is another schematic view of a connection set of a hydroponic device for liquid supply in accordance with the present invention; and

FIG. 10 is a perspective view of a hydroponic device for liquid supply with plant cultivation assembly in accordance with the present invention.

### DETAILED DESCRIPTION OF THE PREFERRED EMBODIMENTS

The present invention is more specifically described in the following paragraphs by reference to the drawings attached only by way of example.

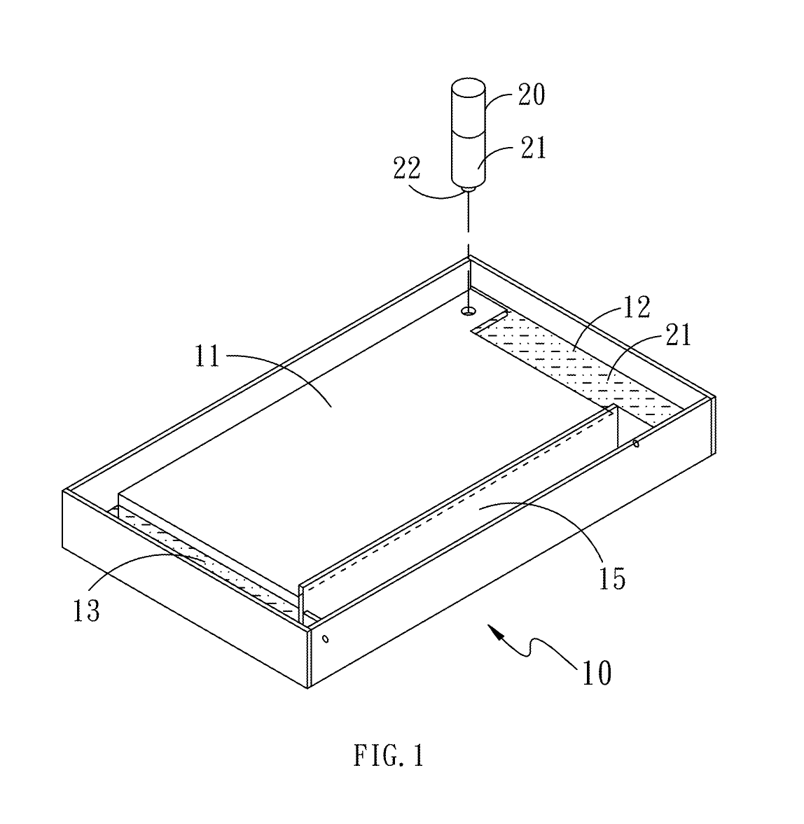

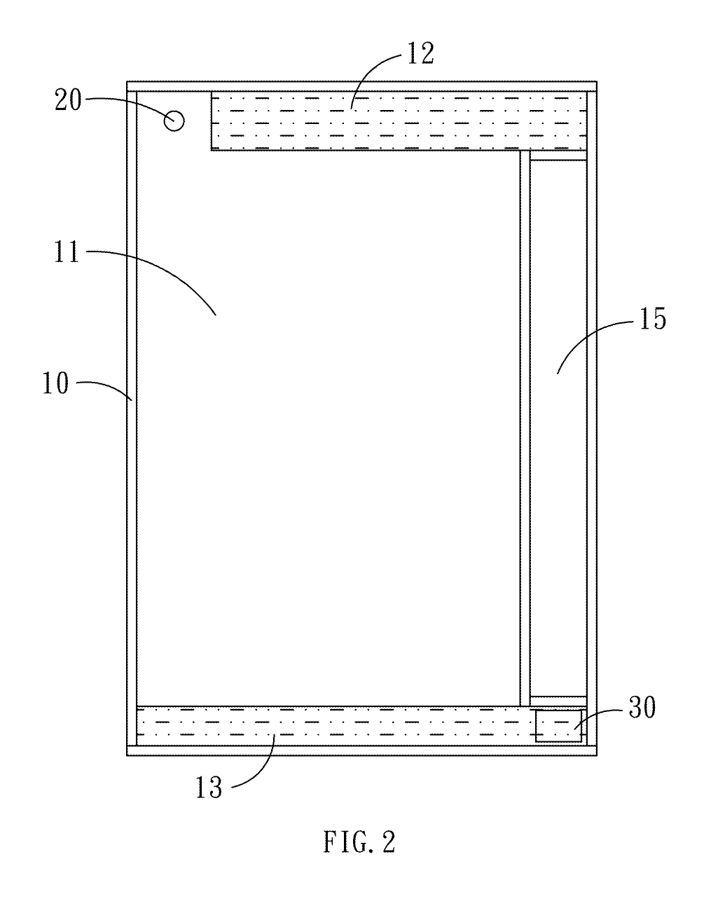

With reference to FIGS. 1 and 2, the hydroponic device for liquid supply comprises a plate 10, a bottle 20 and a motor 30. The plate 10 has an open space for filling liquid therein, and comprises a first flume 12, a second flume 13, a connection set 15 and a diversion panel 11. The diversion panel 11 is mounted in the open space to partition the first flume 12, the second flume 13 and the connection set 15. The bottle 20 is filled with culture solution 21 and has an opening head 22. The opening head 22 is inserted into the division panel 11 and attached to liquid surface to pour the culture solution 21 slowly into the plate 10 via breaking through the surface tension of water. The motor 30 is mounted in the plate 10 and connected to the second flume 13 and the connection set 15, to pump the liquid. The first flume 12 is connected to the connection set 15 to introduce the liquid into the second flume 13, and then to form a circulating fluid loop

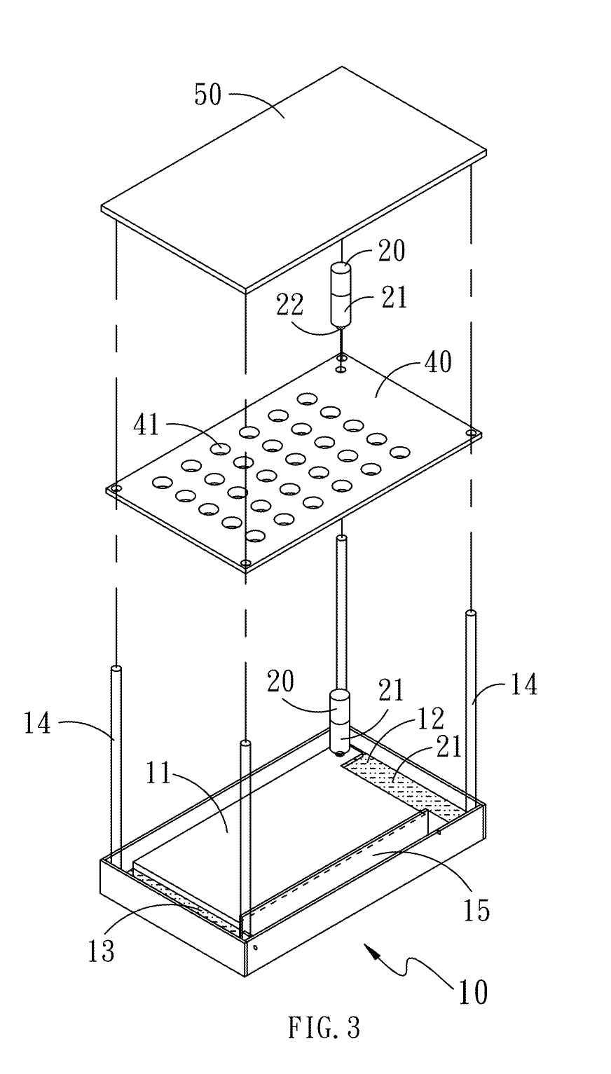

With reference to FIGS. 2 and 3, the plate 10 further comprises multiple brackets 14, a planting board 40, and an LED light board 50. The brackets 14 are mounted on the plate 10. The planting board 40 is mounted onto the brackets 14 and corresponding to the plate 10. The LED light board 50 is mounted on the planting board 40 and fixed by the brackets 14. As such, a plant cultivation assembly is formed as a whole

The planting board 40 further comprises multiple holes 41. Seedlings are disposed in the holes 41 respectively and separately. The planting board 40 is mounted fixedly corresponding to the diversion panel 11. The motor 30 pumps the liquid from the second flume 13. The liquid is introduced into the first flume 12 through the connection set 15, whereby the diluted culture solution 21 in the circulating fluid loop can flow cyclically and provide sufficient water and nutrient for the growing of the seedlings. Also, the circulating fluid loop can reduce the losses of water and nutrient and utilize the water and nutrient repeatedly.

Additionally, the LED light board 50 can be used for regulating temperature and light sources in order to provide illumination and stable conditions appropriately to accelerate the growing of the seedlings.

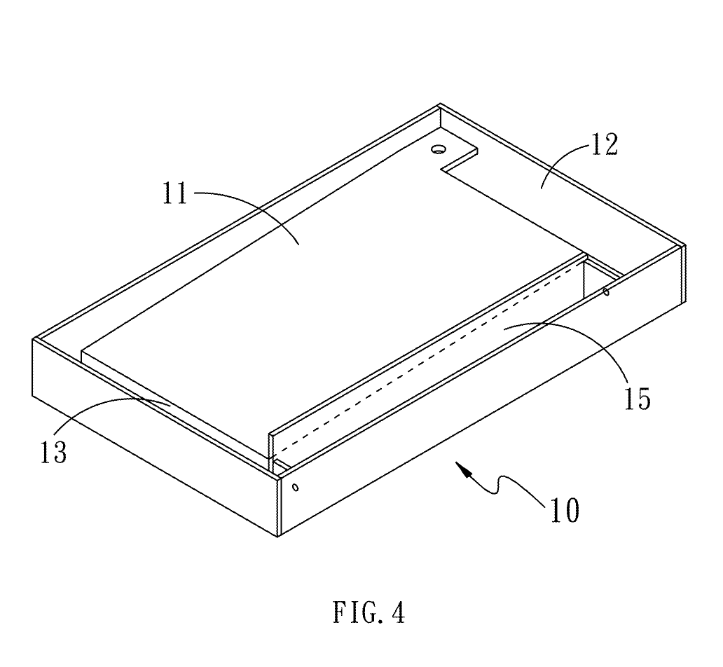

In one aspect, the diversion panel 11 is a flat plane (as shown in FIG. 1). Due to the height difference between the liquid surface of the first flume 12 and the second flume 13, the liquid surface of the first flume 12 is higher than the diversion panel 11, such that the liquid can flow through the diversion panel 11 to the first flume 12. Then, by using the motor 30 to pump the culture solution 21 in the second flume 13, and introducing the culture solution 21 into the first flume 12 via the connection set 15, the purpose of circulating fluid loop for the liquid flowing cyclically is achieved. With reference to FIG. 4, the diversion panel 11 also can be an inclined plane. The culture solution 21 in the first flume 12 can flows more fluently because of the slope along the diversion panel 11.

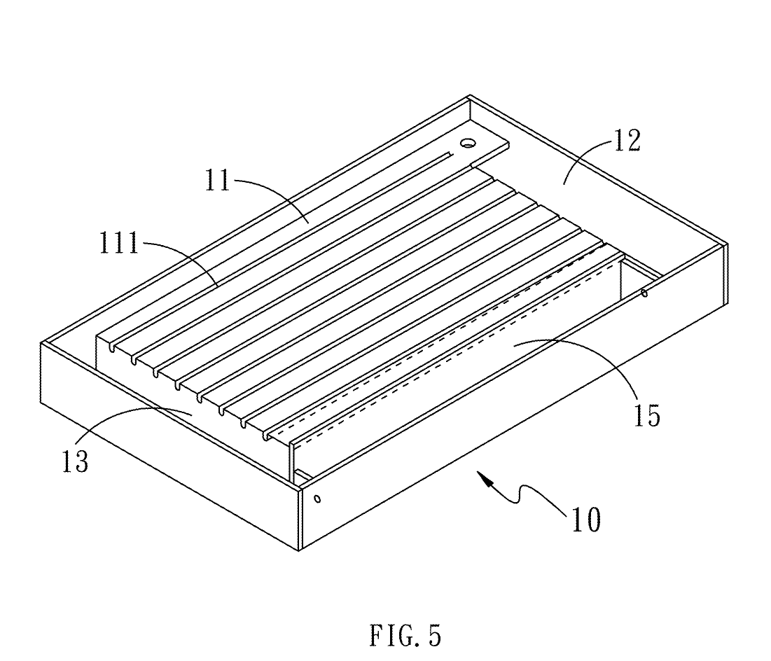

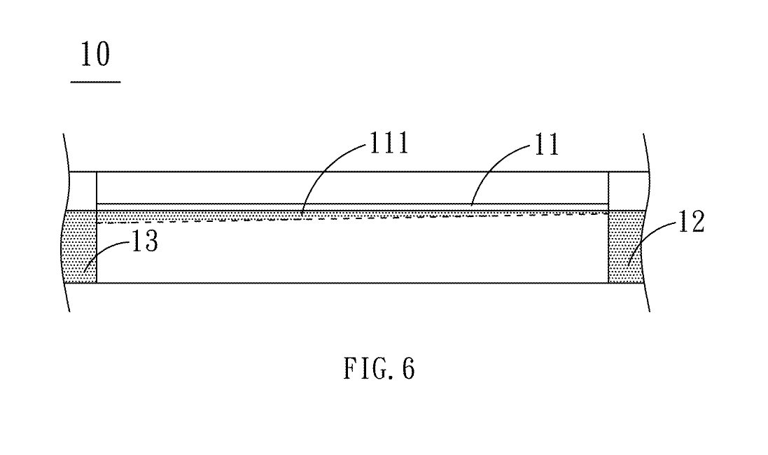

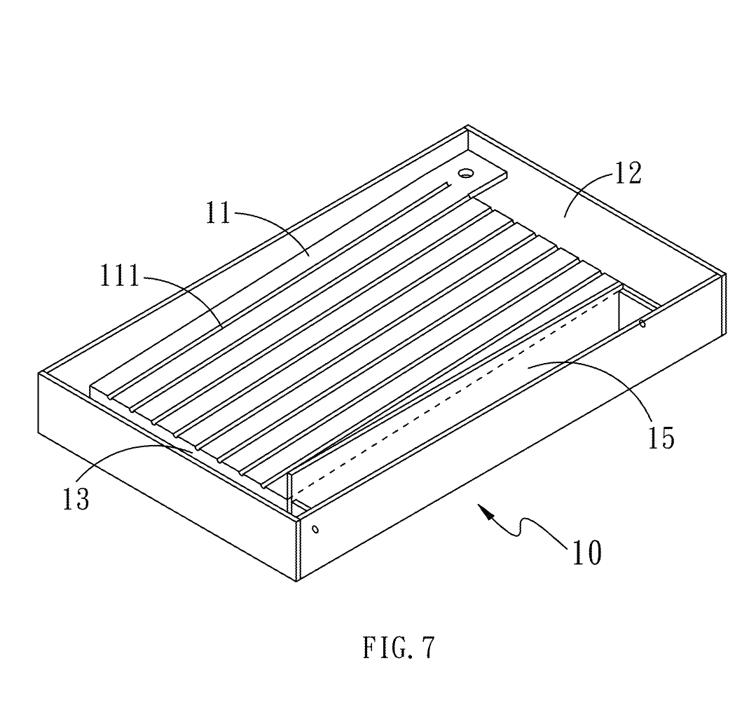

In one aspect, with reference to FIG. 5, the diversion panel 11 is a flat plane, and has multiple guiding grooves 111. The guiding grooves 111 are level grooves. The culture solution 21 can flow more fluently and be guided accurately between the first flume 12 and the second flume 13 through the level grooves. In another aspect, with reference to FIG. 6, the diversion panel 11 is a flat plane, and has multiple guiding grooves 111. The guiding grooves 111 are slanting grooves. The culture solution 21 also can flow more fluently and be guided accurately between the first flume 12 and the second flume 13 through the slanting grooves. In yet another aspect, with reference to FIG. 7, the diversion panel 11 is an inclined plane, and has multiple guiding grooves 111. The guiding grooves 111 are slanting grooves. The culture solution 21 also can flow more fluently and be guided accurately between the first flume 12 and the second flume 13 through the slanting grooves.

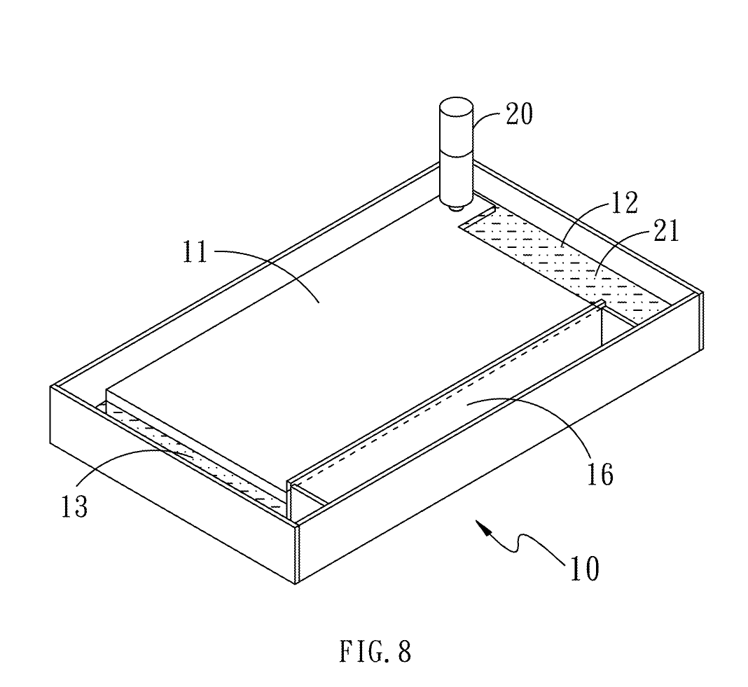

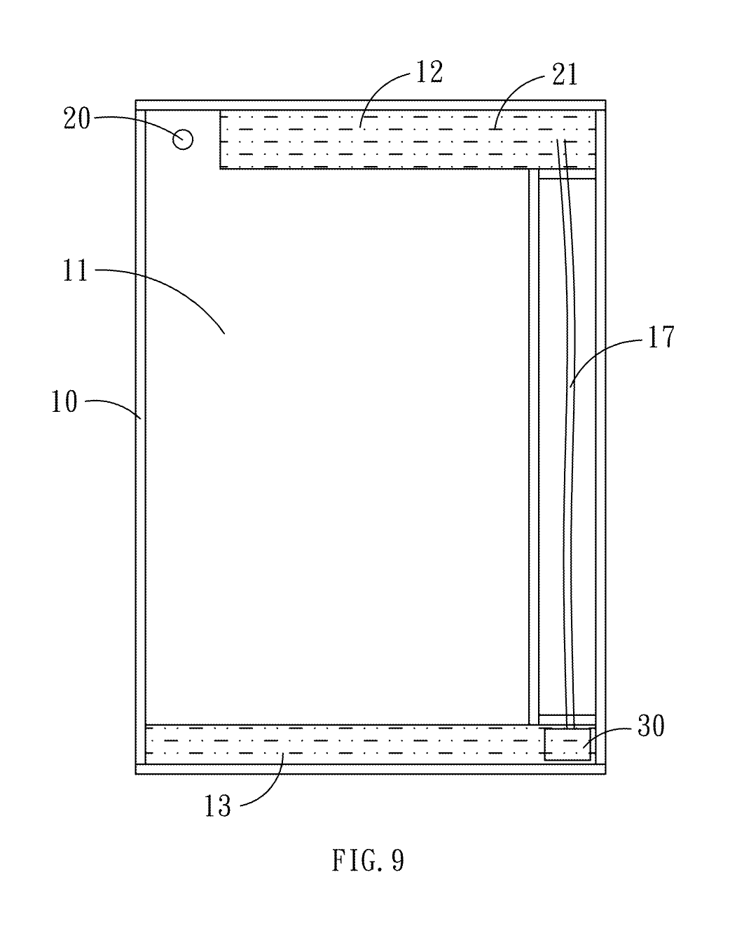

With reference to FIG. 8, the connection set 15 can be a channel 16. The motor 30 pumps the culture solution 21 to the first flume 12, and the culture solution 21 is introduced into the first flume 12 via the channel 16, in order to achieve the action of cyclical flowing. Optionally, with reference to FIG. 9, the connection set 15 can be a tube 17. The motor 30 pumps the culture solution 21 to the first flume 12, and the culture solution 21 is introduced into the first flume 12 via the tube 17, in order to achieve the action of cyclical flowing.

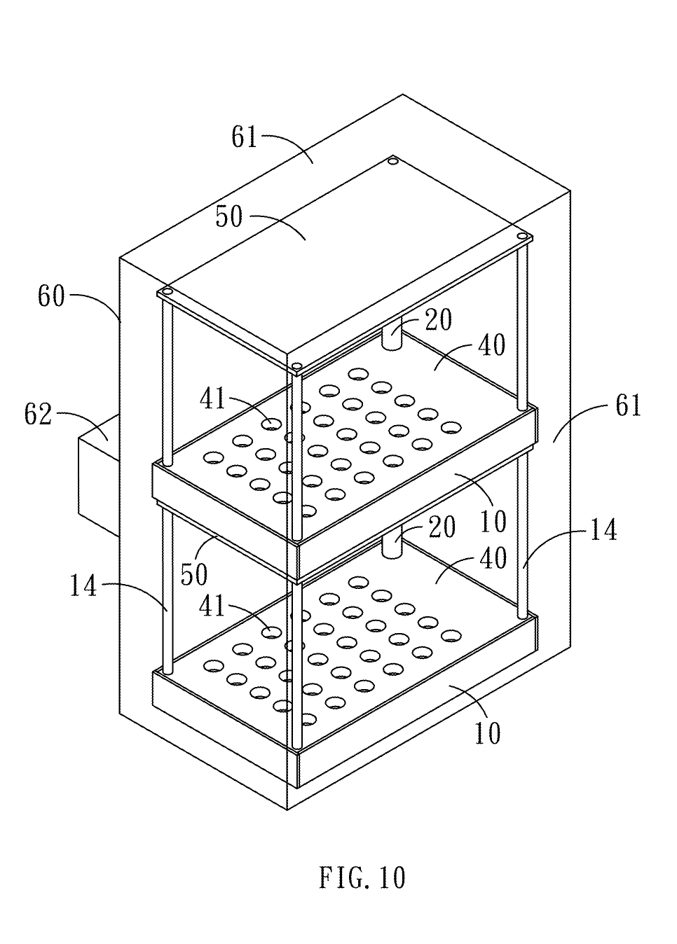

As the description above, with reference to FIG. 10, the plate 10 further comprises multiple brackets 14, the planting board 40 is mounted onto the brackets 14 and corresponding to the plate 10 and the LED light board 50 is fixed by the brackets 14 and mounted on the planting board 40, to form a plant cultivation assembly as a whole. Moreover, the hydroponic device according to the invention further comprises multiple plant cultivation assemblies mounted parallelly in the brackets 14.

Additionally, each of the plant cultivation assemblies further comprises an air-conditioner 60. The air-conditioners 60 are mounted around the plant cultivation assemblies respectively and correspondingly. Each of the air-conditioner 60 is formed by multiple sealing sheets 61 and comprises a conditioning part 62 mounted therein, which is beneficial to the seedlings to grow stably in a well-controlled environment.

In summation of the description above, the present invention provides a hydroponic device for supply that can work much better than conventional devices. While numerous characteristics and advantages of the present invention have been set forth in the foregoing description, together with details of the structure and features of the invention, those skilled in the art might practice the invention with modification within the spirit and scope of the claims. Therefore, the extent of the present invention should not be limited to the specific embodiments set forth, and include any changes and modifications made in the details, especially in matters of shape, size, and arrangement of parts within the principles of the invention.

1. A hydroponic device for liquid supply, comprising: a plate, having an open space for filling liquid therein, and comprising:
a first flume;
a second flume;
a connection set; and
a diversion panel having a first side and a second side opposite to the first side and mounted in the open space to partition the first flume, the second flume and the connection set, wherein the first flume is disposed along the first side of the diversion panel and the second flume is disposed along the second side of the diversion panel, so as to allow liquid to flow from the first flume to the second flume through the diversion panel;
a bottle, filled with a culture solution, and having an opening head which is inserted into the division panel and attached to liquid surface to pour the culture solution slowly into the first flume; and
a motor, mounted in the plate and coupled between the second flume and the connection set to pump the liquid, so that the liquid is driven to flow from the second flume back to the first flume through the connection set.

2. The hydroponic device for liquid supply of claim 1, wherein the diversion panel is a flat plane.

3. The hydroponic device for liquid supply of claim 1, wherein the diversion panel is an inclined plane.

4. The hydroponic device for liquid supply of claim 1, wherein the diversion panel further comprises multiple guiding grooves, whereby the liquid cyclically flow from the first flume to the second flume.

5. The hydroponic device for liquid supply of claim 4, wherein the guiding grooves are level grooves or slanting grooves, whereby the liquid is guided and flow fluently.

6. The hydroponic device for liquid supply of claim 1, wherein the plate further comprises a planting board and an LED light board which is both mounted in the plate, and form a plant cultivation assembly as a whole.

7. The hydroponic device for liquid supply of claim 6, wherein the plate further comprises multiple brackets, the planting board is mounted onto the brackets and corresponding to the plate, and the LED light board is fixed by the brackets and mounted on the planting board, to form a plant cultivation assembly as a whole.

8. The hydroponic device for liquid supply of claim 7, further having multiple plant cultivation assemblies mounted parallelly in the brackets.

9. The hydroponic device for liquid supply of claim 8, wherein each of the plant cultivation assemblies further comprises an air-conditioner mounted around thereof correspondingly, and each of the air-conditioner is formed by multiple sealing sheets and comprises a conditioning part mounted therein.

10. The hydroponic device for liquid supply of claim 6, wherein the planting board is mounted corresponding to the diversion panel and further comprises multiple holes for disposing seedlings.
